(19) United States
(12) Patent Application Publication
(10) Pub. No.: US 2010/0251650 A1
(43) Pub. Date: Oct. 7, 2010

(54) Simulated shingle structure

(76) Inventor: Theodore L. Davidson, St Basile (CA)

Correspondence Address: Eric Fincham, 316 Knowlton Road, Lac Brome, QC, J0E 1V0, CA

(21) Appl. No.: 12/384,435

(22) Filed: Apr. 3, 2009

(51) Int. Cl. E04D 3/24; B27M 1/08; E04C 2/10

(52) U.S. Cl. 52/314; 144/367; 52/557

(57) ABSTRACT

A simulated shingle structure comprising a wood board with a base and an upper edge, the base having a thickness greater than the upper edge, and a plurality of vertical cuts extending partially through a front face of a board. In one embodiment, a portion of the base is removed such that the shingles will appear to have differing lengths.

### FIELD OF THE INVENTION

The present invention relates to construction and more particularly, relates to a simulated wood shake siding and in particular, to simulated shakes formed from a larger sheet of wood.

### BACKGROUND OF THE INVENTION

Wooden shakes are a well known and attractive material used in construction. In particular, cedar shakes provide a desirable material for siding and roofing, having been extensively utilized for many years. Although popular, shakes are quite expensive and require a great deal of expensive hand-labour to install. In order to overcome this problem, the industry has proposed many different solutions such as using simulated shakes made from metallic materials (such as aluminum and galvanized steel), minerals (cement and asbestos compositions), and various other plastic laminates.

Unfortunately, the simulated shakes do not necessarily achieve the desired objective. Many have one or more undesirable attributes such as the simulated shake replicating the molding surface on which it is formed. No matter how closely the shake may resemble its natural counterpart, any roof or siding to which a multiplicity of individual simulated shakes are applied clearly shows the repetitive nature of form and shape inherent in the replicated sameness of each simulated shake. The visual effect is quite different from the no-two-alike look of a natural shake roof or siding. A further disadvantage inherent in individual simulated shakes is the high cost of labour involved in the shake by shake installation.

Installation costs can be substantially decreased by adaptation of a panel expedient, namely a panel which has thereon a multiplicity of simulated shakes in a suitable assembled together configuration. However, one still has a panel to panel identity and also there is a need to conceal joints between adjacent panels.

### SUMMARY OF THE INVENTION

It is therefore an object of the present invention to provide simulated shakes which overcome the disadvantages known in the prior art and which are relatively inexpensive to install.

According to one aspect of the present invention, there is provided a shingle simulating structure comprising a wood board having a base and an upper edge, the base having a thickness greater than a thickness of the upper edge, a plurality of vertical cuts extending partially through a front face of the wood board.

According to a further aspect of the present invention, there is provided a method of manufacturing a shingle structure comprising the steps of supplying a wood plank of a desired length and width, cutting the wood plank diagonally lengthwise to form first and second wood boards each having a lower edge and an upper edge with the lower edge having a greater thickness than the upper edge, and cutting vertical slots at a predetermined distance apart into a front face of the wood board.

In a still further aspect of the present invention, there is provided siding comprising a plurality of rows of longitudinally extending wood boards in an end to end relationship, an upper row partially overlapping a lower row, each wood board having a plurality of spaced apart vertical cuts therein.

The boards of the present invention may be of any suitable wood material. It suffices to say that cost and appearance are two of the factors which must be taken into account when selecting the type of wood to be used. Traditionally, a softwood would be employed.

A preferred method of manufacturing the present invention is to start with a plank which can be sawed diagonally in a length-wise direction to form two equal boards suitable for use in the present invention. Naturally, the width and height of the plank would be selected in order to give the desired final dimensions of the board.

Following the splitting of the plank into two boards, each of the two boards will have a face surface thereof cut by saw or other tool to form vertical slots on the front face. Since the boards are generally triangular in a cross-sectional configuration, the slots are cut to have an initial depth which then diminishes to zero. The slots may be cut at regular or irregular intervals.

In one embodiment of the present invention, the boards have a portion thereof removed adjacent the bottom edge between any two slots. Thus, the board will have a varying height to give the appearance of different shingles being utilized. Again, it may be done on a regular basis or on an irregular basis. Also, the amount of board removed can vary between any two slots if so desired to provide an even more authenticated appearance.

The boards, near their lower or bottom edge, may typically have a thickness of between ¼″ and ¾″. At the upper or top side, the board will typically have a thickness of between ⅛″ and ⅜″.

The slots will typically have a width of between ⅛″ and ⅜″. However, one could form slots having a greater width if so desired.

The height of the board again may be chosen according to the desired effect. Typically, the board would have a height of between 8″ and 10″.

The slots which are formed by cutting will extend into the board for a distance of approximately 20% and 40% of the thickness of the board, this being measured at the base thereof.

The vertical cuts preferably extend for approximately between 60% to 90% of the height of the board.

### BRIEF DESCRIPTION OF THE DRAWINGS

Having thus generally described the invention, reference will be made to the accompanying drawings illustrating an embodiment thereof, in which:

FIG. 1 is a perspective view illustrating the cutting of a plank into two boards;

FIG. 2 is a side perspective view thereof;

FIG. 3 is a perspective view of a board according to one embodiment of the present invention;

FIG. 4 is a front elevational view thereof;

FIG. 5 is a front elevational view of siding formed of the boards of FIGS. 3 and 4;

FIG. 6 is a perspective view of a further embodiment of a board according to the present invention;

FIG. 7 is a front elevational view thereof; and

FIG. 8 is a front elevational view of siding formed by the boards of FIGS. 6 and 7.

### DETAILED DESCRIPTION OF THE INVENTION

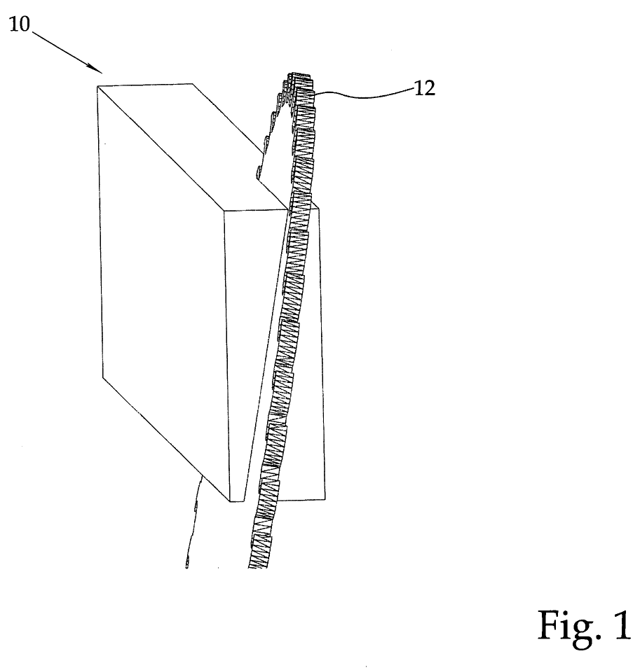

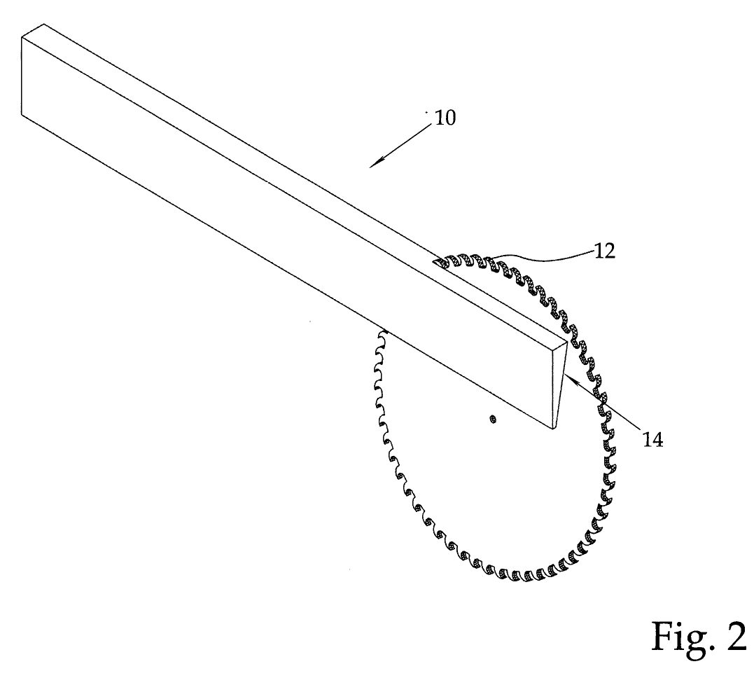

Referring to the drawings in greater detail and by reference characters thereto, there is illustrated in FIGS. 1 and 2 a plank generally designated by reference numeral 10 and which is being cut by saw blade 12 to form a first board 14 and a second board 16.

First board 14 and second board 16 are substantially identical and thus only one will be described in detail herein. Board 14 has a top edge 18 and a bottom edge 20 which, as may be seen, define a substantially triangular cross-sectional configuration. Board 14 has a front face 22 which is the face that is visible when the board is nailed in place.

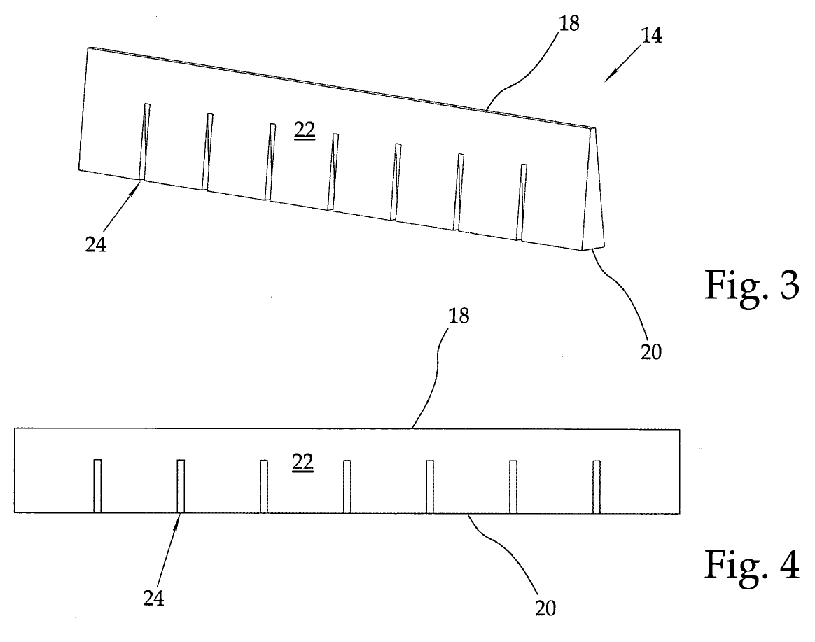

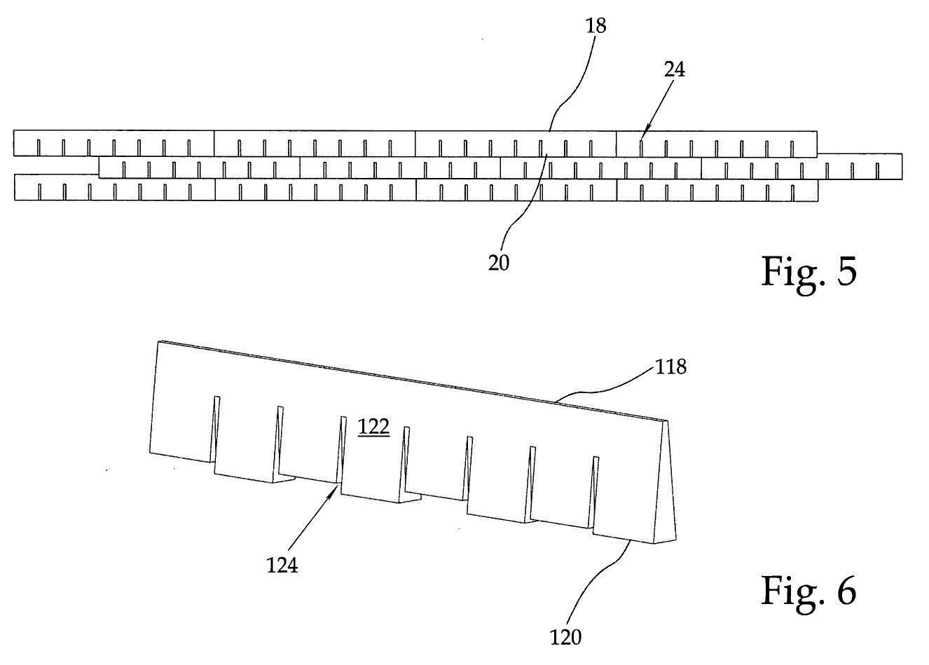

As may be seen in FIGS. 3, 4 and 5, board 14 has a plurality of vertical cuts forming slots 24 therein. Each slot 24 extends to a greater depth adjacent bottom edge 20 than elsewhere and gradually tapers to a zero depth as it approaches top edge 18.

Slots 24 typically have a depth equal to between 20% and 40% of the thickness of the bottom edge 20. Slots 24 preferably extend for approximately between 60% to 90% of the height of the board.

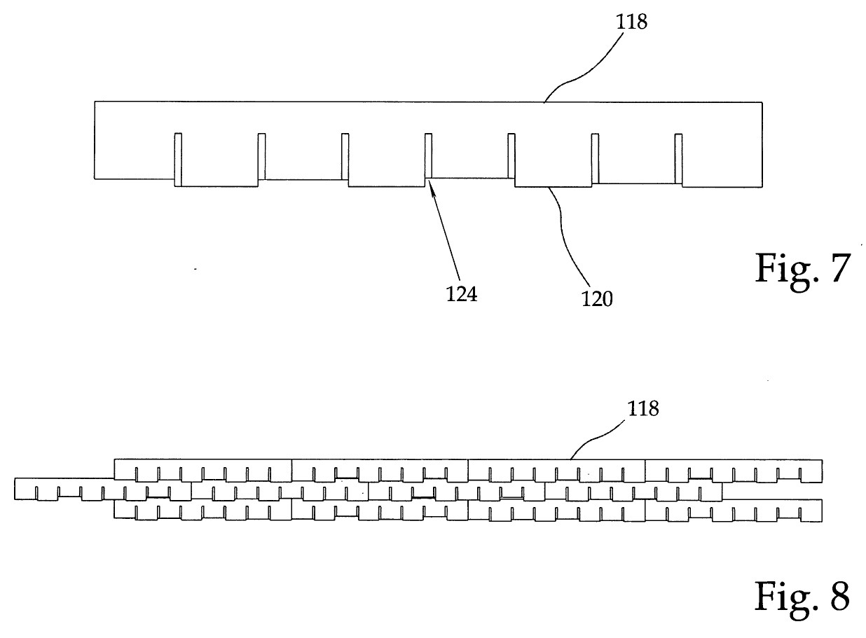

In the embodiment of FIGS. 6 to 8, reference numerals in the 100s are used for similar elements compared to the embodiment of FIGS. 3 to 5. As will be seen, a portion of the board 114 adjacent of the bottom edge 120 has been removed at every second “shake”. This provides a more irregular appearance somewhat similar to conventional shakes. Naturally, the amount removed and the location can be varied.

It will be understood that the above described embodiment is for purposes of illustration only and the changes and modifications may be made thereto without departing from the spirit and scope of the invention.

I claim:

1. A shingle simulating structure comprising:
a wood board having a base and an upper edge;
said base having a thickness greater than a thickness of said upper edge;
a plurality of vertical cuts extending partially through a front face of said wood board.

2. The structure of claim 1 wherein said vertical cuts extend for approximately between 60% to 90% of the height of said wood board.

3. The structure of claim 2 wherein each of said cuts is deeper near said base, said cuts tapering to a zero depth.

4. The structure of claim 3 wherein each of said cuts proximate said base extend into said wood board for a depth of between 20% and 40% of the thickness of said wood board.

5. The structure of claim 4 wherein each of said cuts has a width of between ⅛″ and ⅜″.

6. The structure of claim 1 wherein said wood board has a varying height due to removal of a portion of the base between said vertical cuts at selected locations.

7. A method of manufacturing a shingle structure comprising the steps of supplying a wood plank of a desired length and width, cutting said wood plank diagonally lengthwise to form first and second wood boards each having a lower edge and an upper edge with said lower edge having a greater thickness than said upper edge, and cutting vertical slots at a predetermined distance apart into a front face of said wood board.

8. The method of claim 7 wherein the step of cutting vertical slots comprises the step of cutting vertical slots to extend between 60% to 90% of the height of said wood board.

9. The method of claim 8 wherein said wood board is cut to a maximum depth of between 20% and 40% of the maximum thickness of said wood board.

10. The method of claim 9 wherein said cut is formed deeper near said base with the cut tapering to a zero depth.

11. The method of claim 7 further including the step of cutting said base at selected locations between a pair of said vertical slots to thereby give the appearance of the wood board forming a plurality of shingles of differing heights.

12. The method of claim 8 wherein the step of cutting vertical slots comprises cutting the slots to have a width of between ⅛″ and ⅜″.

13. Siding comprising a plurality of rows of longitudinally extending wood boards in an end to end relationship, an upper row partially overlapping a lower row, each wood board having a plurality of spaced apart vertical cuts therein.

14. The siding of claim 13 wherein said vertical cuts extend for approximately between 60% to 90% of the height of the wood boards.

15. The siding of claim 13 wherein said cuts are deeper near said base, said cuts tapering to a zero depth.

16. The siding of claim 15 wherein said cuts proximate said base extend into said wood board for a depth of between 20% and 40% of the thickness of the wood boards.

17. The siding of claim 15 wherein each of said wood boards has a varying height due to removal of a portion of the base at selected locations between said vertical cuts.
